(19) United States
(12) Patent Application Publication
(10) Pub. No.: US 2019/0156299 A1
(43) Pub. Date: May 23, 2019

(54) MAINTENANCE PROCEDURE GENERATION APPARATUS, MAINTENANCE PROCEDURE GENERATION METHOD, AND RECORDING MEDIUM

(71) Applicant: KABUSHIKI KAISHA TOSHIBA, Tokyo (JP)

(72) Inventors: Akira Hosokawa, Chuo Tokyo (JP); Shinichi Nagano, Yokohama Kanagawa (JP); Gaku Ishii, Kawasaki Kanagawa (JP)

(73) Assignee: KABUSHIKI KAISHA TOSHIBA, Tokyo (JP)

(21) Appl. No.: 15/920,917

(22) Filed: Mar. 14, 2018

(30) Foreign Application Priority Data
Nov. 17, 2017 (JP) 2017-221474

(51) Int. Cl. G06Q 10/00; G06F 17/30

(52) U.S. Cl. CPC G06Q 10/20; G06F 17/30943

(57) ABSTRACT

A maintenance procedure generation apparatus has an information model management unit that manages an information model including detailed information on maintenance work of a maintenance target, a maintenance target acquisition unit that acquires a maintenance target on which maintenance work is to be actually performed from candidates of the maintenance target, a procedure generation unit that generates a first procedure of maintenance work with respect to the maintenance target acquired by the maintenance target acquisition unit based on the information model managed by the information model management unit, and dynamically corrects a second procedure of maintenance work that needs to be performed in the future by a site worker based on maintenance work selected by the site worker, and a work monitoring control unit that acquires information on maintenance work actually performed by the site worker.

### CROSS REFERENCE TO RELATED APPLICATIONS

This application is based upon and claims the benefit of priority from the prior Japanese Patent Application No. 2017-221474, filed on Nov. 17, 2017, the entire contents of which are incorporated herein by reference.

### FIELD

Embodiments of the present invention relate to a maintenance procedure generation apparatus, a maintenance procedure generation method, and a recording medium.

### BACKGROUND

A standard operation procedures manual is often created in maintenance work such as an inspection and a repair of a plant such as a thermal power plant, in order to homogenize the work. It is difficult for the standard operation procedure manual to deal with a case where unexpected trouble is found during the maintenance work or the like because work content and work procedures are fixed irrespective of operation situations and workers. In addition, there is no mechanism for reflecting and utilizing an actual work situation and know-how in the work procedure manual. Thus, it is difficult to perform maintenance work making full use of situations of a site and past experience.

### BRIEF DESCRIPTION OF THE DRAWINGS

FIG. 1 is a block diagram illustrating a schematic configuration of a maintenance procedure generation apparatus according to one embodiment;

FIG. 2 is a diagram illustrating an example of a specific configuration of an information model managed by an information model management unit;

FIG. 3 is a table illustrating an example of an instance corresponding to the information model of FIG. 2;

FIG. 4 is a flowchart illustrating an example of a processing operation of a work editor to generate a maintenance procedure;

FIG. 5 is a flowchart illustrating an example of a processing operation of a site worker to perform maintenance work; and

FIG. 6 is a view illustrating an example of information presented to a second UI unit.

### DETAILED DESCRIPTION

According to one embodiment, a maintenance procedure generation apparatus has an information model management unit that manages an information model including detailed information on maintenance work of a maintenance target, a maintenance target acquisition unit that acquires a maintenance target on which maintenance work is to be actually performed from candidates of the maintenance target, a procedure generation unit that generates a first procedure of maintenance work with respect to the maintenance target acquired by the maintenance target acquisition unit based on the information model managed by the information model management unit, and dynamically corrects a second procedure of maintenance work that needs to be performed in the future by a site worker based on maintenance work selected by the site worker, and a work monitoring control unit that acquires information on maintenance work actually performed by the site worker based on the procedure generated by the procedure generation unit.

Hereinafter, an embodiment will be described with reference to the drawings. In the present specification and accompanying drawings, the description and illustration are given by omitting, changing, or simplifying some components for ease of understanding and convenience in illustration, but technical contents at the extent with which similar functions can be expected are also interpreted as being included in the embodiments.

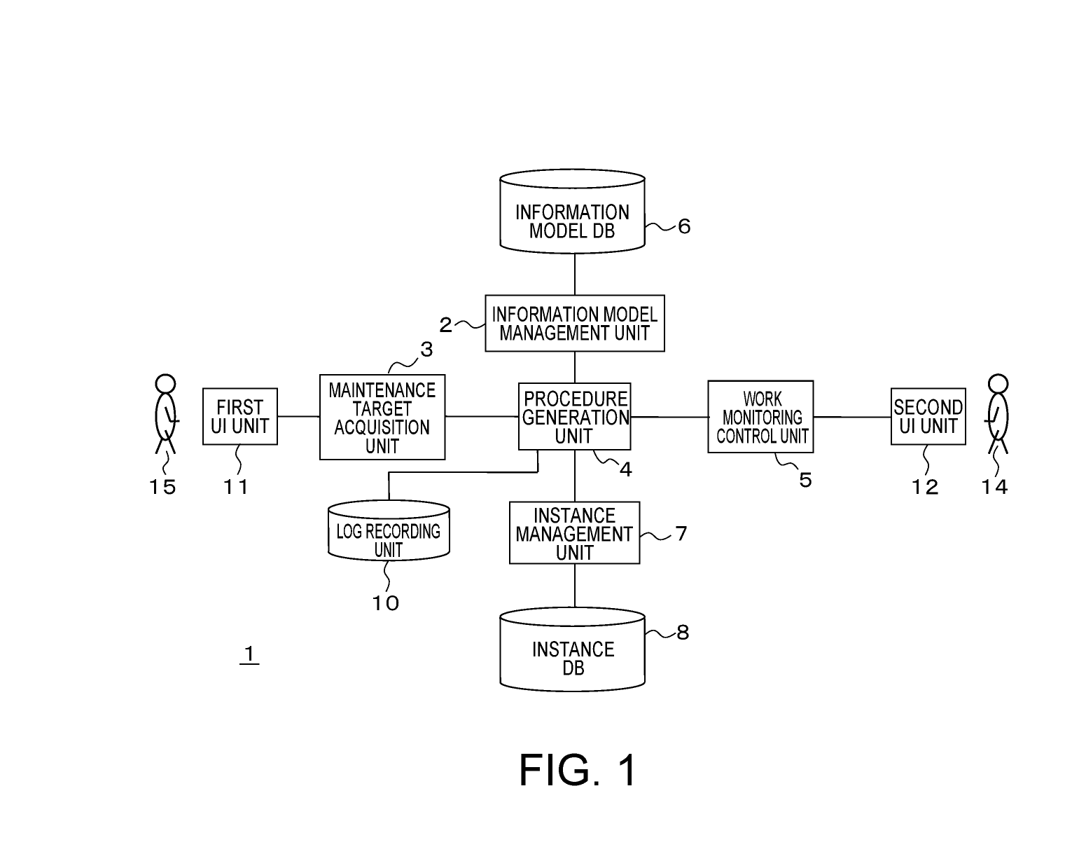

FIG. 1 is a block diagram illustrating a schematic configuration of a maintenance procedure generation apparatus 1 according to one embodiment. The maintenance procedure generation apparatus 1 of FIG. 1 generates a procedure of maintenance work (first procedure of maintenance work) of a plant such as a thermal power plant (hereinafter referred to as a maintenance target). The maintenance procedure generation apparatus 1 of FIG. 1 includes an information model management unit 2, a maintenance target acquisition unit 3, a procedure generation unit 4, and a work monitoring control unit 5.

The information model management unit 2 manages an information model including detailed information of the maintenance work as the maintenance target. The information model will be described later. The information model managed by the information model management unit 2 is stored in an information model database (DB) 6, for example.

The maintenance target acquisition unit 3 acquires the maintenance target designated by a work editor 15 based on the information model managed by the information model management unit 2, or the information model and an instance managed by an instance management unit 7 or various types of information recorded in a log recording unit 10 to be described later. The maintenance target may be a class or a property forming the information model. In addition, the maintenance target may be, for example, the entire plant or some devices in the plant. In addition, the maintenance target may be not only the plant and the device, but also service such as software to operate the plant.

The procedure generation unit 4 generates the maintenance work procedure for the maintenance target acquired by the maintenance target acquisition unit 3 based on the information model managed by the information model management unit 2, or the information model and the instance managed by the instance management unit 7 or various types of information recorded in the log recording unit 10. In addition, the procedure generation unit 4 dynamically corrects the procedure of maintenance work (second procedure of maintenance work) that needs to be performed in the future by a site worker 14 based on maintenance work selected by the site worker 14

The work monitoring control unit 5 acquires information on maintenance work actually performed by the site worker 14 based on the procedure generated by the procedure generation unit 4. When the site worker 14 selects the maintenance work in a different order from the procedure generated by the procedure generation unit 4, the work monitoring control unit 5 notifies the procedure generation unit 4 of the work selected by the site worker while giving a priority to the maintenance work selected by the site worker 14, and acquires a work procedure and presents the acquired work procedure to the site worker 14 as a future work candidate when the procedure generation unit 4 has dynamically corrected the work procedure.

In addition, the maintenance procedure generation apparatus 1 according to the present embodiment includes the instance management unit 7, an instance DB 8, the log recording unit 10, a first user interface unit (first UI unit) 11, and a second user interface unit (second UI unit) 12 as illustrated in FIG. 1.

The instance management unit 7 manages the instance representing a substance of detailed information included in an information model. A specific example of the instance will be described later. The instance DB 8 stores various instances managed by the instance management unit 7.

The log recording unit 10 records the procedure of maintenance work generated or dynamically corrected by the procedure generation unit 4 together with date and time information. The log recording unit 10 may record the procedure of maintenance work generated by the procedure generation unit 4 in association with not only the date and time information but also the information model and the instance, information to identify the work editor 15 who instructs generation of the procedure of maintenance work, or information to identify the site worker 14 who has performed the maintenance work.

The first UI unit 11 has a function of allowing the work editor 15 to input information on the maintenance target, a function of displaying the maintenance procedure generated by the procedure generation unit 4, and the like. The maintenance target acquisition unit 3 acquires a maintenance target on which maintenance work is to be actually performed based on the information input by the work editor 15 via the first UI unit 11. The first UI unit 11 may display the procedure of maintenance work generated by the procedure generation unit 4. The work editor 15 may instruct a change of the maintenance work procedure displayed on the first UI unit 11.

The second UI unit 12 has a function of presenting the procedure of maintenance work dynamically corrected by the procedure generation unit 4 to the site worker 14, a function of inputting the maintenance work selected by the site worker 14, and the like. When the site worker 14 carries an information terminal (for example, a tablet terminal) provided with a display unit, the second UI unit 12 may cause the display unit of the information terminal to display the maintenance work procedure. In addition, the site worker 14 can input the maintenance work that has been actually performed to the second UI unit 12. The work monitoring control unit 5 displays the procedure dynamically corrected by the procedure generation unit 4 as a candidate for future work on the second UI unit 12 while prioritizing the maintenance work input to the second UI unit 12 by the site worker 14.

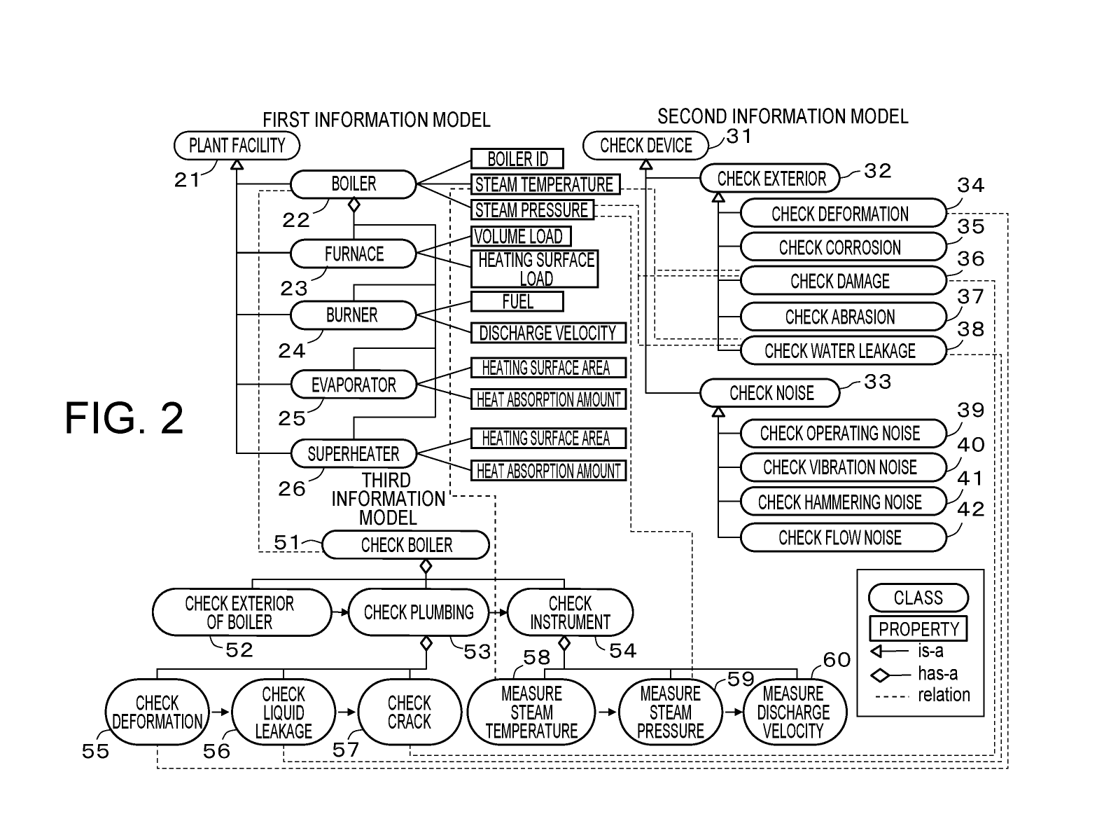

FIG. 2 is a diagram illustrating an example of a specific configuration of the information model managed by the information model management unit 2. The information model is an abstract representation of a concept and a system thereof, a relation, a constraint, a rule, and the like. The information model includes a class representing the concept, a property representing an aspect characterizing the class, a property representing a characteristic and a feature, and a relation representing a relation between elements of the information model. In some technical domains, “information model” is called “ontology” or “data dictionary”. Besides, in an energy domain, it is also called Common Information Model or CIM for short.

The information model of FIG. 2 includes a device information model (first information model) that systematically represents a class and a property of a maintenance target, a work information model (second information model) that systematically represents maintenance work, and a work procedure information model (third information model) that systematically represents a procedures of maintenance work.

In FIG. 2, an ellipse represents the class and a rectangle represents the property. The class can have one or more properties. The class can have one or more child classes (subclasses) and has at most one parent class (superclass). In addition, a property of the parent class is inherited by all child classes thereof. This relation is called “is-a relationship” between classes. The child class can additionally have a child class. Therefore, the structure based on the is-a relationship can take a tree structure rooted in the most abstract class. In FIG. 2, the is-a relationship is indicated by each solid line with Δ at an end that branches into branches, and a class attached with Δ is the parent class between two classes connected by this solid line. In addition, in FIG. 2, a relation between a class and a property of the class is indicated by a solid line without Δ or ⋄ at an end that connects the ellipse and the square.

The relation between classes also has a “has-a relationship” indicating that a class is a part of another class in addition to the is-a relationship. For example, a part with respect to a finished product, such as an engine and a tire with respect to a car, has the has-a relationship in which the finished product is classified as a whole class and its part thereof is classified as a part class. The part class can further have part classes. Thus, the structure based on the has-a relationship can also take a tree structure. In FIG. 2, the “has-a relationship” is indicated by each solid line with ⋄ at an end that branches into branches, and a class attached with ⋄ is the whole class between two classes connected by this solid line.

In addition, a relation between elements in the information model is described as a “relation”. The “relation” has a direction, and is classified into “non-directional”, “uni-directional”, and “bi-directional”. This direction is used, for example, in the case of defining flow of data between elements, an information referring direction, and the like.

In an example of a device information model of FIG. 2, a “plant facility” 21, a “boiler” 22, a “furnace” 23, a “burner” 24, a “evaporator” 25, and a “superheater” 26 are classes, and a “boiler ID”, “steam temperature”, “steam pressure”, and the like are properties. The “plant facility” 21 is a parent class of the “boiler” 22, the “furnace” 23, the “burner” 24, the “evaporator” 25, and the “superheater” 26. On the other hand, the “boiler” 22 has four parts of the “furnace” 23, the “burner” 24, the “evaporator” 25, and the “superheater” 26.

The example of the work information model of FIG. 2 illustrates a class hierarchy in which work abstractly represented is classified. “Perform maintenance and inspection” 31 indicating the most abstract work in this hierarchy has two specialized pieces of work, “visually check” 32 and “check noise” 33 as child classes. These two pieces of work also have work 34 to 38 and 39 to 42, obtained by further specializing the two pieces of work, as child classes.

In the example of the work procedure information model illustrated in FIG. 2, a class “inspection of boiler” 51 collectively referring to the work procedure has three classes of “visual inspection of boiler exterior” 52, “visual inspection of plumbing” 53, and “instrument confirmation” 54 as parts thereof, and has this order as flow. The “visual inspection of plumbing” 53 additionally has three classes of “deformation confirmation” 55, “confirmation of presence or absence of liquid leakage” 56 and “confirmation of presence or absence of crack” 57 as parts thereof. Similarly, the “instrument confirmation” 54 also additionally has three classes pf “measurement of steam temperature” 58, “measurement of steam pressure” 59, and “measurement of discharge velocity” 60.

A solid-line arrow of the work procedure information model defines an order of work having the work procedure. For example, a solid-line arrow between “visual inspection of boiler exterior” and “visual inspection of plumbing” indicates that the next work to be performed after the “visual inspection of boiler exterior” 52 is the “visual inspection of plumbing” 53. Similarly, solid-line arrows among the three pieces of work 55 to 57 which are parts of the “visual inspection of plumbing” 53 define the order of these pieces of work. Here, after the work of “confirmation of presence or absence of crack” 57 is completed, the process returns to the higher-order work “visual inspection of plumbing” 53 having the work of “confirmation of presence or absence of crack” 57 as the part, and the “visual inspection of plumbing” 53 which is the work next to the “instrument confirmation” 54 is performed.

A broken line in FIG. 2 indicates that there is a relation between two elements on both ends of the broken line. For example, a broken line connecting the class “boiler” 22 of the device information model and the class “inspection of boiler” 51 of the work procedure information model indicates that there is a relation between both classes. This relation can define a relation between a class and a property without being limited to the relation between classes. For example, a broken line connecting the property “steam temperature” of the class “boiler” 22 of the device information model and the class “measurement of steam temperature” of the work procedure information model indicates that a value of “steam temperature” is referred to or updated by “measurement of steam temperature”.

The instance according to the present embodiment indicates a substance fleshed with an information model or a database schema as a type. For example, the instance with respect to the device information model describes a value of a property of a class with respect to a facility or a device actually installed in a plant. In addition, the instance of the work procedure information model is obtained by applying a specific work target facility or a device with respect to an abstractly represented work procedure or individual pieces of work. On the other hand, the instance with respect to the database schema corresponds to a record of a table, for example, in the case of a relational database.

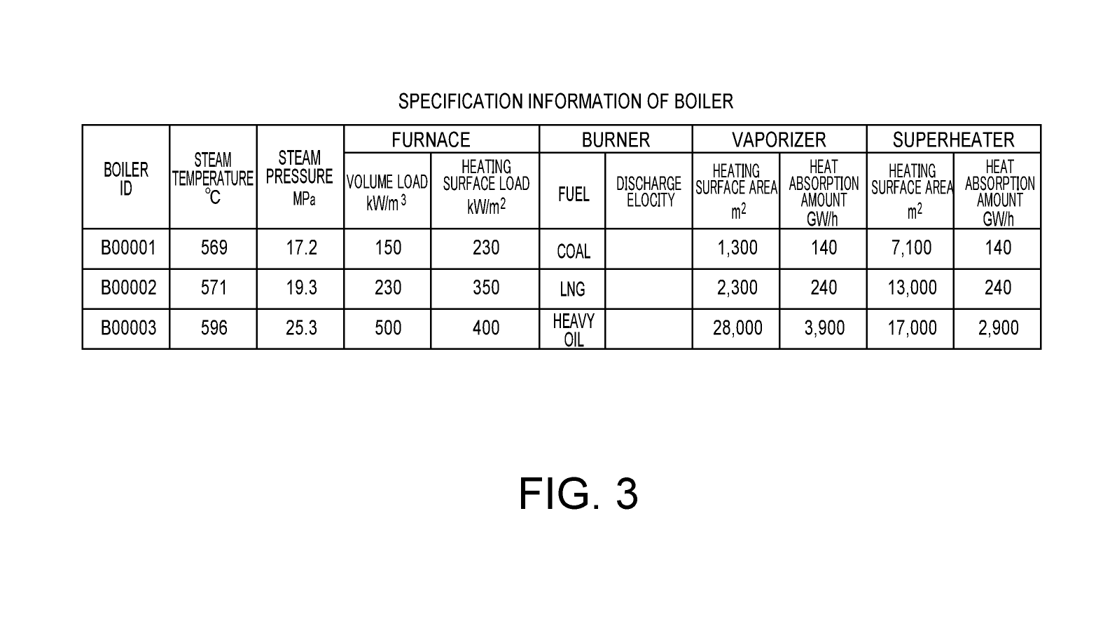

FIG. 3 is a table illustrating an example of the instance corresponding to the information model of FIG. 2. “Specification information of boiler” in FIG. 3 is a table exemplifying three instances of the class “boiler” 22 of the device information model. This table has the three properties of “boiler ID”, “steam temperature” and “steam pressure” of the class “boiler” 22, and properties of the four classes of the “furnace” 23, the “burner” 24, the “evaporator” 25, and the “superheater” 26 in the has-a relationship as data items. Each instance of the “boiler” 22 is described by a combination of values of these properties.

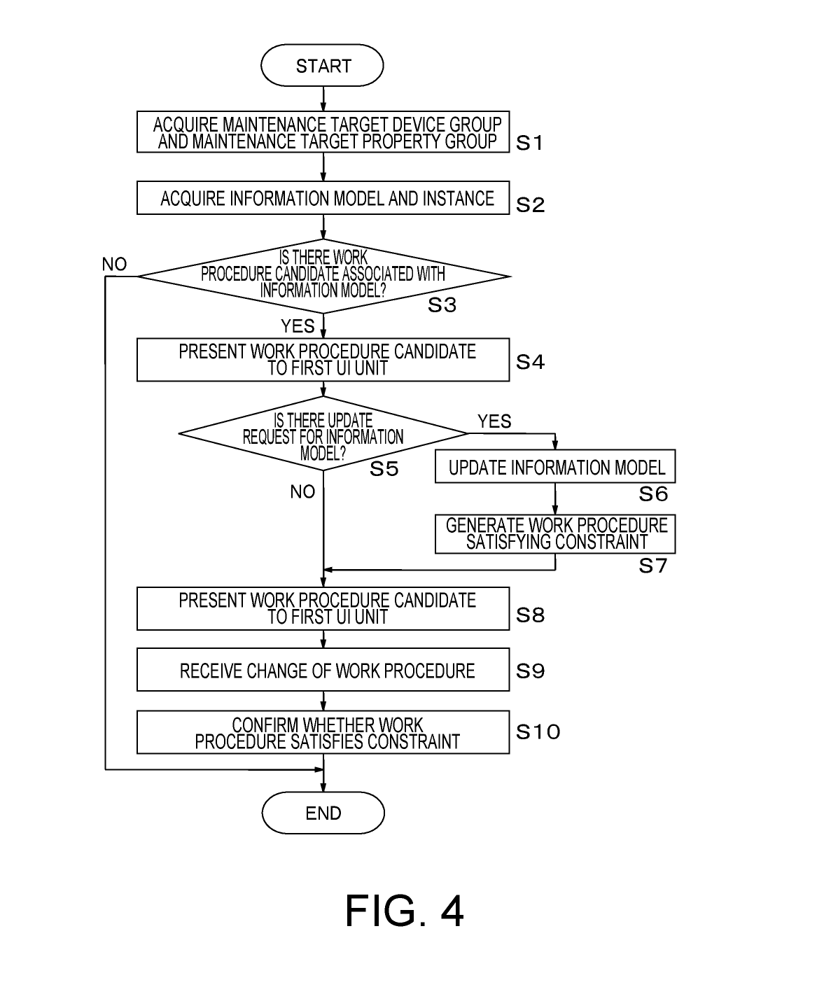

FIG. 4 is a flowchart illustrating an example of a processing operation of the work editor 15 to generate a maintenance procedure. First, the maintenance target acquisition unit 3 acquires a maintenance target class group, a maintenance target property group, or a maintenance target instance based on the information input by the work editor 15 via the first UI unit 11 (Step S1).

Next, the procedure generation unit 4 acquires an information model corresponding to the information acquired in Step S1 from the information model management unit 2, and acquires an instance from the instance management unit 7 (Step S2). In addition, the procedure generation unit 4 may acquire at least one of history information on a maintenance work procedure generated in the past and history information on a maintenance work procedure performed by the site worker 14 in the past. The history information on the maintenance work procedure generated in the past can be acquired from the log recording unit 10. Similarly, the history information on the maintenance work procedure performed by the site worker 14 in the past can be acquired from the log recording unit 10.

Next, the procedure generation unit 4 determines whether there is a work procedure candidate associated with the information model or the instance based on each piece of the information acquired in Step S2 (Step S3). When it is determined that there is the candidate, the first UI unit 11 presents the work procedure candidate (Step S4). On the other hand, when it is determined in Step S3 that there is no work procedure candidate associated with the information model, the processing is ended. One specific example of the presentation is to display the work procedure candidate on a display unit provided in the first UI unit 11. Alternatively, the work procedure candidate may be presented as voice or a print output.

Next, the procedure generation unit 4 determines whether there is an update request for the information model (Step S5). The work editor 15 can make an update request for the information model via the first UI unit 11. In addition, the site worker 14 may also make an update request for the information model via the second UI unit 12.

When it is determined that there is the update request, the procedure generation unit 4 updates the information model (Step S6) and notifies the information model management unit 2. The information model management unit 2 manages the updated information model and updates an information model in the information model DB 6. Next, the procedure generation unit 4 generates a work procedure that satisfies a given constraint based on the updated information model (Step S7).

On the other hand, when it is determined in Step S5 that there is no update request or when the process of Step S7 is ended, the first UI unit 11 presents the work procedure (Step S8). Next, a change of the work procedure made by the work editor 15 is received (Step S9). The work editor 15 can instruct the change of the work procedure via the first UI unit 11 as necessary. When the change of the operation procedure has been instructed, the procedure generation unit 4 confirms whether the changed work procedure satisfies the constraint (Step S10). A confirmed result is presented to the first UI unit 11.

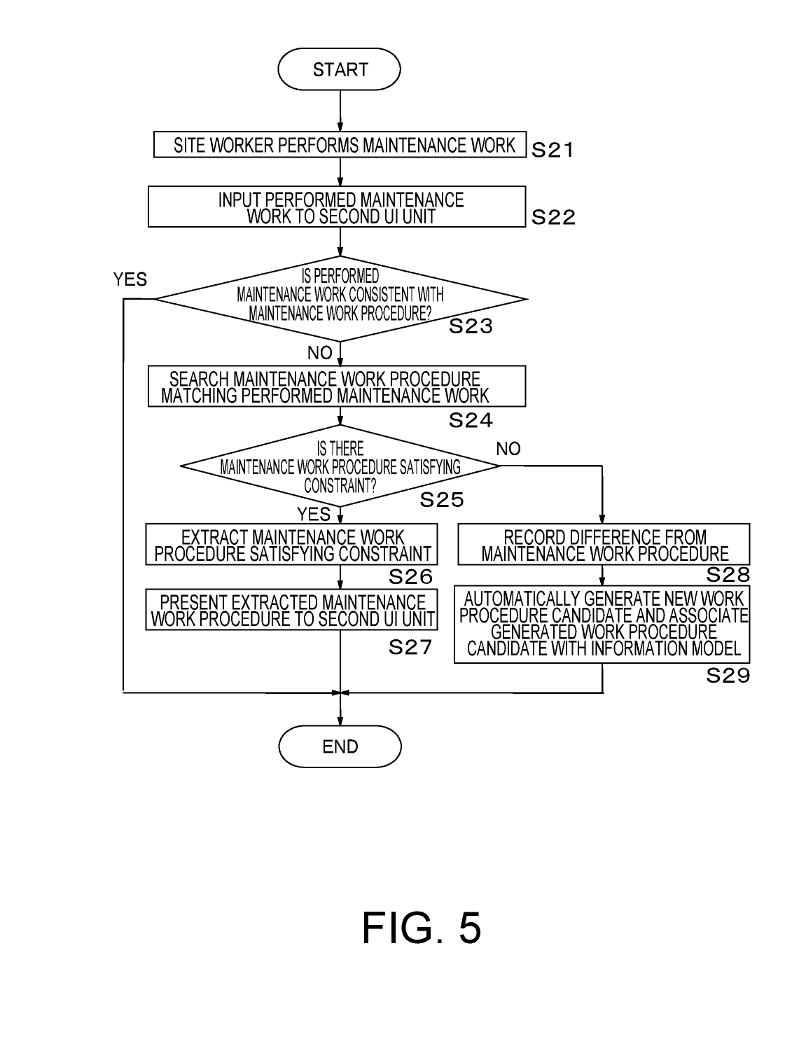

FIG. 5 is a flowchart illustrating an example of a processing operation of the site worker 14 to perform maintenance work. When the site worker 14 has performed maintenance work (Step S21), the site worker 14 inputs content of the performed maintenance work to the second UI unit 12 (Step S22). This input information is sent to the procedure generation unit 4 via the work monitoring control unit 5 and recorded in the log recording unit 10.

Next, the work monitoring control unit 5 compares the maintenance work procedure generated by the procedure generation unit 4 with the maintenance work procedure actually performed by the site worker 14, and determines whether both procedures are consistent with each other (Step S23). When it is determined that both procedures are consistent with each other, the processing is ended, and the apparatus stands by until the next maintenance work of the site worker 14 is performed. On the other hand, when it is determined that both procedures are not consistent with each other, the procedure generation unit 4 searches a procedure matching the maintenance work procedure actually performed by the site worker 14 from the information model (Step S24), and determines whether there is a maintenance work procedure satisfying a constraint condition corresponding to the maintenance work procedure actually performed by the site worker 14 (Step S25). When it is determined that there is the corresponding maintenance work procedure, this maintenance work procedure satisfying the constraint condition is extracted (Step S26). Next, the extracted maintenance work procedure is presented to the second UI unit 12 (Step S27).

When it is determined in Step S25 that there is no corresponding maintenance work procedure, a difference between the maintenance work procedure generated by the procedure generation unit 4 and the maintenance work procedure actually performed by the site worker 14 is sent to the procedure generation unit 4 and recorded in the log recording unit 10 in association with the information model (Step S28). Next, the procedure generation unit 4 automatically generates a new work procedure candidate and associates the generated work procedure candidate with the information model (Step S29). The automatically generated work procedure candidate is sent to the work monitoring control unit 5, and presented to the site worker 14 via the second UI unit 12, and the information model management unit 2 updates the information model.

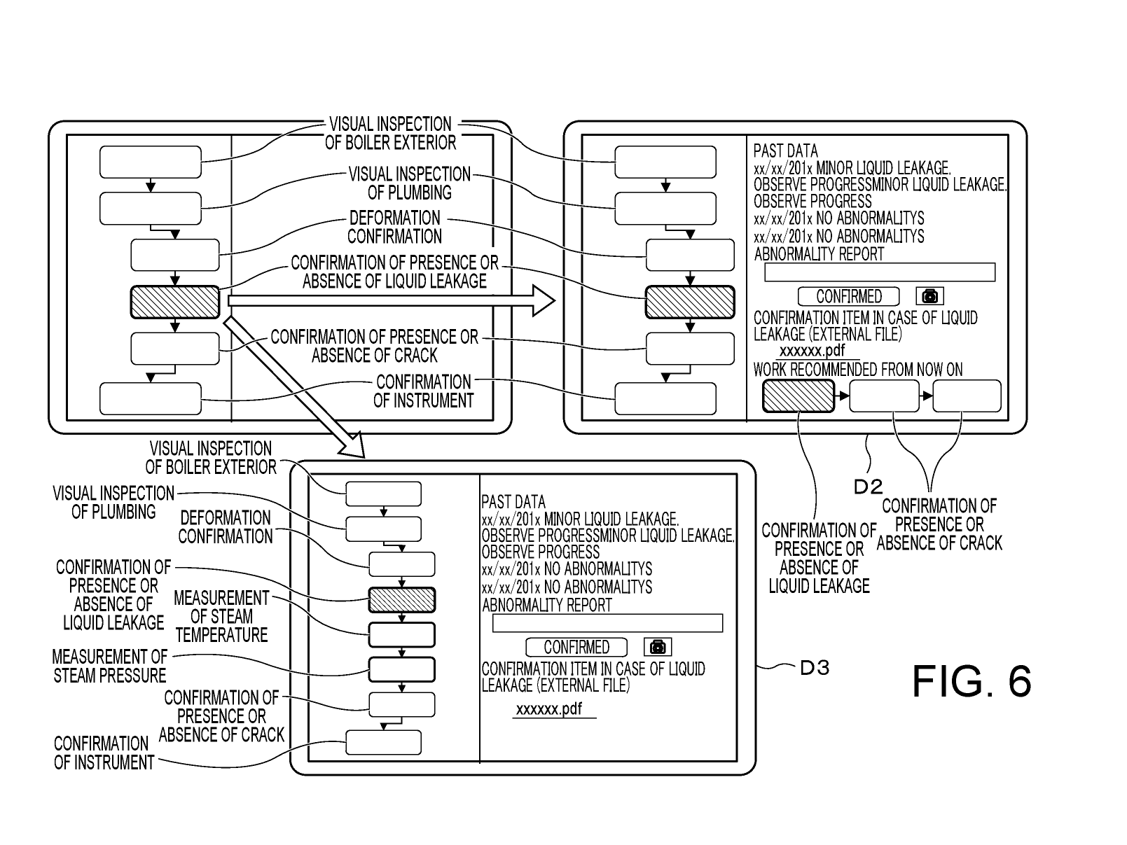

FIG. 6 illustrates an example of information presented to the second UI unit 12. FIG. 6 illustrates an example of displaying the maintenance work procedure and various types of information relating thereto on a tablet terminal carried by the site worker 14. A screen example D1 in FIG. 6 illustrates an example in which the site worker 14 selects work in the order different from the original work procedure. More specifically, the example in which “confirmation of presence or absence of liquid leakage” has been selected first although “confirmation of presence or absence of liquid leakage” needs to be selected after selection of “visual inspection of boiler exterior” or “deformation confirmation” in the original work procedure.

In this case, the work monitoring control unit 5 may display information on “confirmation of presence or absence of liquid leakage” in a right area of the screen and display a work candidate that needs to be performed after the work “confirmation of presence or absence of liquid leakage” as illustrated in a screen example D2 of FIG. 6.

Alternatively, the information model may be updated to generate a new work procedure based on an information model associated with the work “confirmation of presence or absence of liquid leakage”, and the generated work procedure may be presented to the site worker 14 as illustrated in a screen example D3 of FIG. 6. The screen examples D1 to D3 in FIG. 6 are examples, and various modifications thereof are conceivable.

In this manner, the maintenance work procedure is generated in accordance with the instruction from the work editor 15, and further, the maintenance work procedure that needs to be performed by the site worker 14 in the future is dynamically corrected when the generated maintenance work is different from the maintenance work selected by the site worker 14 in the present embodiment. As a result, it is possible to perform the appropriate maintenance work in accordance with an intention of the site worker 14. In addition, since the history of the maintenance work procedure generated by the work editor 15 in the past and the maintenance work know-how of the site worker 14 are considered at the time of generating the maintenance work, it is possible to generate the optimum work procedure in accordance with the device group and the property group on which the maintenance work is to be performed.

According to the maintenance procedure generation apparatus 1 of the present embodiment, a maintenance procedure generation method, and a maintenance procedure generation program, it is possible to realize plan-do-check-action (PDCA) from work procedure creation to an operation thereof, and to easily generate the optimum work procedure for the situation and purpose.

At least a part of the maintenance procedure generation apparatus 1 described in the above embodiments may be configured by hardware or software. When configured by the software, a program to implement at least some functions of the maintenance procedure generation apparatus 1 may be stored in a storage medium, such as a flexible disk and a CD-ROM, and then may be read and executed by a computer. The recording medium is not limited to a detachable storage medium, such as a magnetic disk and an optical disc, and may be a fixed recording medium, such as a hard disk and a memory.

In addition, the program to implement at least some functions of the maintenance procedure generation apparatus 1 may be distributed through a communication line (including radio communication) such as the Internet. Further, the program that has been encrypted, modulated, or compressed, may be distributed through a wired line or a wireless line, such as the Internet, or may be stored in a recording medium and then may be distributed.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A maintenance procedure generation apparatus comprising:
an information model management unit that manages an information model including detailed information on maintenance work of a maintenance target;
a maintenance target acquisition unit that acquires a maintenance target on which maintenance work is to be actually performed from candidates of the maintenance target;
a procedure generation unit that generates a first procedure of maintenance work with respect to the maintenance target acquired by the maintenance target acquisition unit based on the information model managed by the information model management unit, and dynamically corrects a second procedure of maintenance work that needs to be performed in the future by a site worker based on maintenance work selected by the site worker; and
a work monitoring control unit that acquires information on maintenance work actually performed by the site worker based on the procedure generated by the procedure generation unit.

2. The maintenance procedure generation apparatus according to claim 1, wherein
the work monitoring control unit notifies the procedure generation unit of work selected by the site worker when the site worker selects the maintenance work of a procedure different from the procedure generated by the procedure generation unit, and
the procedure generation unit dynamically correct the procedure generated once such that the maintenance work of the maintenance target acquired by the maintenance target acquisition unit is performed while prioritizing the maintenance work selected by the site worker.

3. The maintenance procedure generation apparatus according to claim 1, further comprising
a first user interface unit that allows a work editor to input information on a maintenance target,
wherein the maintenance target acquisition unit acquires the maintenance target on which maintenance work is to be actually performed based on the information input by the work editor via the first user interface unit.

4. The maintenance procedure generation apparatus according to claim 1, further comprising
a second user interface unit that presents the second procedure of maintenance work dynamically corrected by the procedure generation unit to the site worker.

5. The maintenance procedure generation apparatus according to claim 4, wherein
the second user interface unit presents, to the site worker, at least one of detailed information on the maintenance work selected by the site worker and the second procedure of maintenance work that needs to be executed after the maintenance work selected by the site worker.

6. The maintenance procedure generation apparatus according to claim 1, wherein
the information model managed by the information model management unit includes a first information model systematically representing a class and a property of a maintenance target, a second information model systematically representing the maintenance work, and a third information model systematically representing the first procedure of maintenance work, and the first, second and third information models are associated with each other.

7. The maintenance procedure generation apparatus according to claim 1, further comprising
an instance management unit that manages an instance representing a substance of the detailed information included in the information model,
wherein the procedure generation unit generates the first procedure of maintenance work with respect to the maintenance target acquired by the maintenance target acquisition unit based on the information model managed by the information model management unit and the instance managed by the instance management unit.

8. The maintenance procedure generation apparatus according to claim 7, wherein
the procedure generation unit generates the first procedure of maintenance work with respect to the maintenance target acquired by the maintenance target acquisition unit based on at least one of history information on the first procedure of maintenance work generated in the past and history information on the second procedure of maintenance work performed by the site worker in the past in addition to the information model managed by the information model management unit and the instance managed by the instance management unit.

9. The maintenance procedure generation apparatus according to claim 1, wherein
the work monitoring control unit records information on maintenance work performed by the site worker in the past, and the procedure generation unit dynamically corrects the second procedure of maintenance work that needs to be performed by the site worker in the future based on the maintenance work actually performed by the site worker and the procedure generated by the procedure generation unit.

10. A maintenance procedure generation method comprising:
managing an information model including detailed information on maintenance work of a maintenance target;
acquiring a maintenance target on which maintenance work is to be actually performed from candidates of the maintenance target;
generating a first procedure of maintenance work with respect to the acquired maintenance target based on the information model, and dynamically correcting a second procedure of maintenance work that needs to be performed in the future by a site worker based on the maintenance work selected by the site worker; and
acquiring information on maintenance work actually performed by the site worker based on the generated procedure.

11. The maintenance procedure generation method according to claim 10, wherein
the acquiring information on maintenance work notifies work selected by the site worker when the site worker selects the maintenance work of a procedure different from the generated procedure, and
the generating the second procedure dynamically corrects the procedure generated once such that the maintenance work of the acquired maintenance target is performed while prioritizing the maintenance work selected by the site worker.

12. The maintenance procedure generation method according to claim 10, further comprising
allowing a work editor to input information on a maintenance target,
wherein the acquiring the maintenance target acquires the maintenance target on which maintenance work is to be actually performed based on the information input by the work editor.

13. The maintenance procedure generation method according to claim 10, further comprising
presenting the second procedure of maintenance work dynamically corrected to the site worker.

14. The maintenance procedure generation method according to claim 13, wherein
the presenting the procedure presents, to the site worker, at least one of detailed information on the maintenance work selected by the site worker and the second procedure of maintenance work that needs to be executed after the maintenance work selected by the site worker.

15. The maintenance procedure generation method according to claim 10, wherein
the managed information model includes a first information model systematically representing a class and a property of a maintenance target, a second information model systematically representing the maintenance work, and a third information model systematically representing the first procedure of maintenance work, and the first, second and third information models are associated with each other.

16. The maintenance procedure generation method according to claim 10, further comprising
managing an instance representing a substance of the detailed information included in the information model,
wherein the first procedure of maintenance work is generated with respect to the acquired maintenance target based on the managed information model and the managed instance.

17. The maintenance procedure generation method according to claim 16, wherein
the generating the procedure generates the second procedure of maintenance work with respect to the maintenance target acquired by the maintenance target acquisition unit based on at least one of history information on the first procedure of maintenance work generated in the past and history information on the second procedure of maintenance work performed by the site worker in the past in addition to the managed information model and the managed instance.

18. The maintenance procedure generation method according to claim 10, wherein
the acquiring information records information on maintenance work performed by the site worker in the past, and the generating the procedure dynamically corrects the second procedure of maintenance work that needs to be performed by the site worker in the future based on the maintenance work actually performed by the site worker and the generated procedure.

19. A recording medium that stores a program, the program that causes a computer to execute:
managing an information model including detailed information on maintenance work of a maintenance target;
acquiring a maintenance target on which maintenance work is to be actually performed from candidates of the maintenance target;
generating a first procedure of maintenance work with respect to the acquired maintenance target based on the information model, and dynamically correcting a second procedure of maintenance work that needs to be performed in the future by a site worker based on the maintenance work selected by the site worker; and
acquiring information on maintenance work actually performed by the site worker based on the generated procedure.

20. The recording medium according to claim 19, wherein
the acquiring information on maintenance work notifies work selected by the site worker when the site worker selects the maintenance work of a procedure different from the generated procedure, and
the generating the second procedure dynamically correct the procedure generated once such that the maintenance work of the acquired maintenance target is performed while prioritizing the maintenance work selected by the site worker.
